(19) United States
(12) Patent Application Publication
(10) Pub. No.: US 2024/0327606 A1
(43) Pub. Date: Oct. 3, 2024

(54) CURABLE LIQUID RUBBER COMPOSITIONS AND METHODS OF USING SAME

(71) Applicant: Patricia Doeden, Hillsborough, NC (US)

(72) Inventor: James Doeden, Hillsborough, NC (US)

(21) Appl. No.: 18/292,931

(22) PCT Filed: Jul. 29, 2022
(86) PCT No.: PCT/US2022/038955

§ 371 Date: Jan. 29, 2024

Related U.S. Application Data
(60) Provisional application No. 63/227,327, filed on Jul. 29, 2021.

(51) Int. Cl. C08K 3/36; C08K 5/05; C08K 5/14; C08K 9/06

(52) U.S. Cl. CPC C08K 3/36; C08K 5/05; C08K 5/14; C08K 9/06

(57) ABSTRACT

The present disclosure provides curable rubber compositions and methods of curing same.

### PRIORITY CLAIM

This application claims priority to U.S. Provisional Patent Application Ser. No. 63/227,327, filed on Jul. 29, 2021, the entire contents of which are incorporated herein by reference and relied upon.

### BACKGROUND

Commercially available rubber curable rubber compositions generally provide poor thermal expansion and physical properties compared to vulcanized rubber. In addition, curing processes for many rubber compositions require harsh conditions not suitable for many applications, for example when the curable liquid rubber composition is used as a potting material to protect electronic components from moisture, abrasion, vibration, etc. A need persists for curable liquid rubber compositions that can be cured using relatively mild conditions and, after curing, exhibit thermal expansion and physical properties that more closely match the thermal expansion and surface properties of vulcanized rubber.

### SUMMARY

The present disclosure provides curable rubber compositions and methods of curing same.

In some embodiments, the present disclosure provides a rubber composition comprising: a polyisoprene; a filler; an antioxidant; an accelerator; and a crosslinking agent.

In other embodiments, the present disclosure provides a rubber composition comprising: a polyisoprene; a filler; a primary accelerator; a secondary accelerator; and an activator.

In other embodiments, the present disclosure provides a rubber composition comprising: a polyisoprene; no filler; a co-agent; an antioxidant; and a cross-linking agent.

In still other embodiments, the present disclosure provides a rubber composition comprising: a polyisoprene; a filler; a co-agent; and a peroxide cross-linking agent.

In some embodiments, the curable rubber compositions disclosed herein are useful as a durable potting compound, for example to waterproof and/or protect sensitive electronics. For example and without limitation, the present disclosure provides a method of protecting an electronic device, the method comprising: preparing a rubber composition of any one preceding claim; substantially surrounding the electronic device with the rubber composition; and thereafter curing the rubber composition by contacting the rubber composition with UV light and/or heat.

### DETAILED DESCRIPTION

The present disclosure provides curable rubber compositions (e.g., liquid rubber compositions) and methods of using same.

In particular, the present disclosure provides curable rubber compositions (e.g., liquid rubber compositions) that have improved properties over vulcanized natural rubber. Curable rubber compositions of the present disclosure may, for example, have an accelerated curing process compared to vulcanized rubber (e.g., may be curable at or below about 65° C. and in about 4 hours or less). Curable rubber compositions of the present disclosure may be curable in the presence of sulfur. After curing, the rubber compositions of the present disclosure may be optically clear or have an amber or gray hue. Cured rubber compositions of the present disclosure may have a hardness value of about 80-90 Shore A. Preferably, cured rubber compositions of the present disclosure can be easily bonded to vulcanized rubber, optionally with the aid of an adhesive. Shrink rates of curable rubber compositions of the present disclosure are low during and after curing processes. After curing, curable rubber compositions of the present disclosure may have a relatively low glass transition point, such as about −10° C. or lower.

### 1. Curable Rubber Compositions

Generally, curable rubber compositions consistent with the present disclosure include a polyisoprene, an accelerator or a cross-linker, optionally a filler, and optionally an anti-oxidant.

In some embodiments, the curable rubber composition can be bonded after curing (e.g., using a cyanoacrylate-type adhesive) to vulcanized rubber.

In some embodiments, the polyisoprene component comprises, consists essentially of, or consists of a natural polyisoprene, such as natural rubber (e.g., rubber derived from tree sap).

In some embodiments, the polyisoprene component comprises, consists essentially of, or consists of a synthetic polyisoprene, such as a synthetically polymerized composition comprising, consisting essentially of, or consisting of repeating isoprene monomer units.

In some embodiments, the polyisoprene comprises, consists essentially of, or consists of repeating cis-1,4-polyisoprene units:

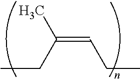

In some embodiments, the polyisoprene comprises, consists essentially of, or consists of repeating trans-1,4-polyisoprene units:

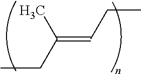

In some embodiments, the polyisoprene comprises, consists essentially of, or consists of repeating 3,4-addition isoprene units:

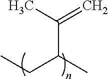

In some embodiments, the polyisoprene comprises, consists essentially of, or consists of repeating 1,2-addition isoprene units:

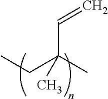

In some embodiments, the polyisoprene component has an average molecular weight of about 40,000 to about 200,000; for example about 60,000 to about 80,000; about 80,000 to about 100,000; about 100,000 to about 120,000; about 120,000 to about 140,000; about 140,000 to about 160,000; about 160,000 to about 180,000; or about 180,000 to about 200,000; for example about 40,000, about 41,000, about 42,000, about 43,000, about 44,000, about 45,000, about 46,000, about 47,000, about 48,000, about 49,000, about 50,000, about 51,000, about 52,000, about 53,000, about 54,000, about 55,000, about 56,000, about 57,000, about 58,000, about 59,000, about 60,000, about 61,000, about 62,000, about 63,000, about 64,000, about 65,000, about 66,000, about 67,000, about 68,000, about 69,000, about 70,000, about 71,000, about 72,000, about 73,000, about 74,000, about 75,000, about 76,000, about 77,000, about 78,000, about 79,000, about 80,000, about 81,000, about 82,000, about 83,000, about 84,000, about 85,000, about 86,000, about 87,000, about 88,000, about 89,000, about 90,000, about 91,000, about 92,000, about 93,000, about 94,000, about 95,000, about 96,000, about 97,000, about 98,000, about 99,000, about 100,000, about 101,000, about 102,000, about 103,000, about 104,000, about 105,000, about 106,000, about 107,000, about 108,000, about 109,000, about 110,000, about 111,000, about 112,000, about 113,000, about 114,000, about 115,000, about 116,000, about 117,000, about 118,000, about 119,000, about 120,000, about 121,000, about 122,000, about 123,000, about 124,000, about 125,000, about 126,000, about 127,000, about 128,000, about 129,000, about 130,000, about 131,000, about 132,000, about 133,000, about 134,000, about 135,000, about 136,000, about 137,000, about 138,000, about 139,000, about 140,000, about 141,000, about 142,000, about 143,000, about 144,000, about 145,000, about 146,000, about 147,000, about 148,000, about 149,000, about 150,000, about 151,000, about 152,000, about 153,000, about 154,000, about 155,000, about 156,000, about 157,000, about 158,000, about 159,000, about 160,000, about 161,000, about 162,000, about 163,000, about 164,000, about 165,000, about 166,000, about 167,000, about 168,000, about 169,000, about 170,000, about 171,000, about 172,000, about 173,000, about 174,000, about 175,000, about 176,000, about 177,000, about 178,000, about 179,000, about 180,000, about 181,000, about 182,000, about 183,000, about 184,000, about 185,000, about 186,000, about 187,000, about 188,000, about 189,000, about 190,000, about 191,000, about 192,000, about 193,000, about 194,000, about 195,000, about 196,000, about 197,000, about 198,000, about 199,000, or about 200,000.

In some embodiments, the polyisoprene component comprises, consists essentially of, or consists of a commercially-available polyisoprene, such as Isolene 400-S(H.B. Fuller), Cariflex IR0310 (Kraton Performance Polymers, Inc.), and/or Cariflex IR0310 K (Kraton Performance Polymers, Inc.).

One or more accelerators may be included in the curable rubber composition. For example and without limitation, trimethylolpropane trimethacrylate (“TRIM”) may be included as the only accelerator, or as one of a plurality of accelerators present. TRIM may be present, if at all, in an amount of about 0.1 part per hundred rubber (“phr”) to about 5 phr, for example about 0.5 phr to about 2 phr, such as about 0.1 phr, about 0.2 phr, about 0.3 phr, about 0.4 phr, about 0.5 phr, about 0.6 phr, about 0.7 phr, about 0.8 phr, about 0.9 phr, about 1 phr, about 1.1 phr, about 1.2 phr, about 1.3 phr, about 1.4 phr, about 1.5 phr, about 1.6 phr, about 1.7 phr, about 1.8 phr, about 1.9 phr, about 2 phr, about 2.1 phr, about 2.2 phr, about 2.3 phr, about 2.4 phr, about 2.5 phr, about 2.6 phr, about 2.7 phr, about 2.8 phr, about 2.9 phr, about 3 phr, about 3.1 phr, about 3.2 phr, about 3.3 phr, about 3.4 phr, about 3.5 phr, about 3.6 phr, about 3.7 phr, about 3.8 phr, about 3.9 phr, about 4 phr, about 4.1 phr, about 4.2 phr, about 4.3 phr, about 4.4 phr, about 4.5 phr, about 4.6 phr, about 4.7 phr, about 4.8 phr, about 4.9 phr, or about 5 phr.

N-tert-butyl-2-benzothiazole sulfenamide (“TBBS”) may be present as the only accelerator, or as one of a plurality of accelerators. When included, TBBS may be present in an amount of about 0.01 phr to about 2 phr, for example about 0.1 to about 1 phr, such as about 0.01 phr, about 0.02 phr, about 0.03 phr, about 0.04 phr, about 0.05 phr, about 0.06 phr, about 0.07 phr, about 0.08 phr, about 0.09 phr, about 0.1 phr, about 0.11 phr, about 0.12 phr, about 0.13 phr, about 0.14 phr, about 0.15 phr, about 0.16 phr, about 0.17 phr, about 0.18 phr, about 0.19 phr, about 0.2 phr, about 0.21 phr, about 0.22 phr, about 0.23 phr, about 0.24 phr, about 0.25 phr, about 0.26 phr, about 0.27 phr, about 0.28 phr, about 0.29 phr, about 0.3 phr, about 0.31 phr, about 0.32 phr, about 0.33 phr, about 0.34 phr, about 0.35 phr, about 0.36 phr, about 0.37 phr, about 0.38 phr, about 0.39 phr, about 0.4 phr, about 0.41 phr, about 0.42 phr, about 0.43 phr, about 0.44 phr, about 0.45 phr, about 0.46 phr, about 0.47 phr, about 0.48 phr, about 0.49 phr, about 0.5 phr, about 0.51 phr, about 0.52 phr, about 0.53 phr, about 0.54 phr, about 0.55 phr, about 0.56 phr, about 0.57 phr, about 0.58 phr, about 0.59 phr, about 0.6 phr, about 0.61 phr, about 0.62 phr, about 0.63 phr, about 0.64 phr, about 0.65 phr, about 0.66 phr, about 0.67 phr, about 0.68 phr, about 0.69 phr, about 0.7 phr, about 0.71 phr, about 0.72 phr, about 0.73 phr, about 0.74 phr, about 0.75 phr, about 0.76 phr, about 0.77 phr, about 0.78 phr, about 0.79 phr, about 0.8 phr, about 0.81 phr, about 0.82 phr, about 0.83 phr, about 0.84 phr, about 0.85 phr, about 0.86 phr, about 0.87 phr, about 0.88 phr, about 0.89 phr, about 0.9 phr, about 0.91 phr, about 0.92 phr, about 0.93 phr, about 0.94 phr, about 0.95 phr, about 0.96 phr, about 0.97 phr, about 0.98 phr, about 0.99 phr, about 1 phr, about 1.01 phr, about 1.02 phr, about 1.03 phr, about 1.04 phr, about 1.05 phr, about 1.06 phr, about 1.07 phr, about 1.08 phr, about 1.09 phr, about 1.1 phr, about 1.11 phr, about 1.12 phr, about 1.13 phr, about 1.14 phr, about 1.15 phr, about 1.16 phr, about 1.17 phr, about 1.18 phr, about 1.19 phr, about 1.2 phr, about 1.21 phr, about 1.22 phr, about 1.23 phr, about 1.24 phr, about 1.25 phr, about 1.26 phr, about 1.27 phr, about 1.28 phr, about 1.29 phr, about 1.3 phr, about 1.31 phr, about 1.32 phr, about 1.33 phr, about 1.34 phr, about 1.35 phr, about 1.36 phr, about 1.37 phr, about 1.38 phr, about 1.39 phr, about 1.4 phr, about 1.41 phr, about 1.42 phr, about 1.43 phr, about 1.44 phr, about 1.45 phr, about 1.46 phr, about 1.47 phr, about 1.48 phr, about 1.49 phr, about 1.5 phr, about 1.51 phr, about 1.52 phr, about 1.53 phr, about 1.54 phr, about 1.55 phr, about 1.56 phr, about 1.57 phr, about 1.58 phr, about 1.59 phr, about 1.6 phr, about 1.61 phr, about 1.62 phr, about 1.63 phr, about 1.64 phr, about 1.65 phr, about 1.66 phr, about 1.67 phr, about 1.68 phr, about 1.69 phr, about 1.7 phr, about 1.71 phr, about 1.72 phr, about 1.73 phr, about 1.74 phr, about 1.75 phr, about 1.76 phr, about 1.77 phr, about 1.78 phr, about 1.79 phr, about 1.8 phr, about 1.81 phr, about 1.82 phr, about 1.83 phr, about 1.84 phr, about 1.85 phr, about 1.86 phr, about 1.87 phr, about 1.88 phr, about 1.89 phr, about 1.9 phr, about 1.91 phr, about 1.92 phr, about 1.93 phr, about 1.94 phr, about 1.95 phr, about 1.96 phr, about 1.97 phr, about 1.98 phr, about 1.99 phr, or about 2 phr.

Tetramethyl thiuram disulfide (“TMTD”) may be present as the only accelerator, or as one of a plurality of accelerators. When included, TMTD may be present in an amount of about 0.01 phr to about 2 phr, for example about 0.1 to about 1 phr, such as about 0.01 phr, about 0.02 phr, about 0.03 phr, about 0.04 phr, about 0.05 phr, about 0.06 phr, about 0.07 phr, about 0.08 phr, about 0.09 phr, about 0.1 phr, about 0.11 phr, about 0.12 phr, about 0.13 phr, about 0.14 phr, about 0.15 phr, about 0.16 phr, about 0.17 phr, about 0.18 phr, about 0.19 phr, about 0.2 phr, about 0.21 phr, about 0.22 phr, about 0.23 phr, about 0.24 phr, about 0.25 phr, about 0.26 phr, about 0.27 phr, about 0.28 phr, about 0.29 phr, about 0.3 phr, about 0.31 phr, about 0.32 phr, about 0.33 phr, about 0.34 phr, about 0.35 phr, about 0.36 phr, about 0.37 phr, about 0.38 phr, about 0.39 phr, about 0.4 phr, about 0.41 phr, about 0.42 phr, about 0.43 phr, about 0.44 phr, about 0.45 phr, about 0.46 phr, about 0.47 phr, about 0.48 phr, about 0.49 phr, about 0.5 phr, about 0.51 phr, about 0.52 phr, about 0.53 phr, about 0.54 phr, about 0.55 phr, about 0.56 phr, about 0.57 phr, about 0.58 phr, about 0.59 phr, about 0.6 phr, about 0.61 phr, about 0.62 phr, about 0.63 phr, about 0.64 phr, about 0.65 phr, about 0.66 phr, about 0.67 phr, about 0.68 phr, about 0.69 phr, about 0.7 phr, about 0.71 phr, about 0.72 phr, about 0.73 phr, about 0.74 phr, about 0.75 phr, about 0.76 phr, about 0.77 phr, about 0.78 phr, about 0.79 phr, about 0.8 phr, about 0.81 phr, about 0.82 phr, about 0.83 phr, about 0.84 phr, about 0.85 phr, about 0.86 phr, about 0.87 phr, about 0.88 phr, about 0.89 phr, about 0.9 phr, about 0.91 phr, about 0.92 phr, about 0.93 phr, about 0.94 phr, about 0.95 phr, about 0.96 phr, about 0.97 phr, about 0.98 phr, about 0.99 phr, about 1 phr, about 1.01 phr, about 1.02 phr, about 1.03 phr, about 1.04 phr, about 1.05 phr, about 1.06 phr, about 1.07 phr, about 1.08 phr, about 1.09 phr, about 1.1 phr, about 1.11 phr, about 1.12 phr, about 1.13 phr, about 1.14 phr, about 1.15 phr, about 1.16 phr, about 1.17 phr, about 1.18 phr, about 1.19 phr, about 1.2 phr, about 1.21 phr, about 1.22 phr, about 1.23 phr, about 1.24 phr, about 1.25 phr, about 1.26 phr, about 1.27 phr, about 1.28 phr, about 1.29 phr, about 1.3 phr, about 1.31 phr, about 1.32 phr, about 1.33 phr, about 1.34 phr, about 1.35 phr, about 1.36 phr, about 1.37 phr, about 1.38 phr, about 1.39 phr, about 1.4 phr, about 1.41 phr, about 1.42 phr, about 1.43 phr, about 1.44 phr, about 1.45 phr, about 1.46 phr, about 1.47 phr, about 1.48 phr, about 1.49 phr, about 1.5 phr, about 1.51 phr, about 1.52 phr, about 1.53 phr, about 1.54 phr, about 1.55 phr, about 1.56 phr, about 1.57 phr, about 1.58 phr, about 1.59 phr, about 1.6 phr, about 1.61 phr, about 1.62 phr, about 1.63 phr, about 1.64 phr, about 1.65 phr, about 1.66 phr, about 1.67 phr, about 1.68 phr, about 1.69 phr, about 1.7 phr, about 1.71 phr, about 1.72 phr, about 1.73 phr, about 1.74 phr, about 1.75 phr, about 1.76 phr, about 1.77 phr, about 1.78 phr, about 1.79 phr, about 1.8 phr, about 1.81 phr, about 1.82 phr, about 1.83 phr, about 1.84 phr, about 1.85 phr, about 1.86 phr, about 1.87 phr, about 1.88 phr, about 1.89 phr, about 1.9 phr, about 1.91 phr, about 1.92 phr, about 1.93 phr, about 1.94 phr, about 1.95 phr, about 1.96 phr, about 1.97 phr, about 1.98 phr, about 1.99 phr, or about 2 phr.

In some embodiments, TBBS is present in an amount of about 0.01 phr to about 2 phr, for example about 0.1 phr to about 1 phr; and TMTD is also present in an amount of about 0.01 phr to about 2 phr, for example about 0.1 phr to about 1 phr. The TBBS and the TMTD may be present in equal amounts (e.g., in an approximate 1:1 ratio), or may be present in a ratio of TBBS to TMTD of about 1.1:1 to about 5:1, for example about 1.1:1, about 1.2:1, about 1.3:1, about 1.4:1, about 1.5:1, about 1.6:1, about 1.7:1, about 1.8:1, about 1.9:1, about 2:1, about 2.1:1, about 2.2:1, about 2.3:1, about 2.4:1, about 2.5:1, about 2.6:1, about 2.7:1, about 2.8:1, about 2.9:1, about 3:1, about 3.1:1, about 3.2:1, about 3.3:1, about 3.4:1, about 3.5:1, about 3.6:1, about 3.7:1, about 3.8:1, about 3.9:1, about 4:1, about 4.1:1, about 4.2:1, about 4.3:1, about 4.4:1, about 4.5:1, about 4.6:1, about 4.7:1, about 4.8:1, about 4.9:1, or about 5:1.

One or more cross-linkers may be present. In some embodiments, no cross-linker is present. When present the cross-linker(s) may be present in a total amount of about 0.5 phr to about 10 phr, for example about 1 phr to about 5 phr, such as about 0.5 phr, about 0.6 phr, about 0.7 phr, about 0.8 phr, about 0.9 phr, about 1 phr, about 1.1 phr, about 1.2 phr, about 1.3 phr, about 1.4 phr, about 1.5 phr, about 1.6 phr, about 1.7 phr, about 1.8 phr, about 1.9 phr, about 2 phr, about 2.1 phr, about 2.2 phr, about 2.3 phr, about 2.4 phr, about 2.5 phr, about 2.6 phr, about 2.7 phr, about 2.8 phr, about 2.9 phr, about 3 phr, about 3.1 phr, about 3.2 phr, about 3.3 phr, about 3.4 phr, about 3.5 phr, about 3.6 phr, about 3.7 phr, about 3.8 phr, about 3.9 phr, about 4 phr, about 4.1 phr, about 4.2 phr, about 4.3 phr, about 4.4 phr, about 4.5 phr, about 4.6 phr, about 4.7 phr, about 4.8 phr, about 4.9 phr, about 5 phr, about 5.1 phr, about 5.2 phr, about 5.3 phr, about 5.4 phr, about 5.5 phr, about 5.6 phr, about 5.7 phr, about 5.8 phr, about 5.9 phr, about 6 phr, about 6.1 phr, about 6.2 phr, about 6.3 phr, about 6.4 phr, about 6.5 phr, about 6.6 phr, about 6.7 phr, about 6.8 phr, about 6.9 phr, about 7 phr, about 7.1 phr, about 7.2 phr, about 7.3 phr, about 7.4 phr, about 7.5 phr, about 7.6 phr, about 7.7 phr, about 7.8 phr, about 7.9 phr, about 8 phr, about 8.1 phr, about 8.2 phr, about 8.3 phr, about 8.4 phr, about 8.5 phr, about 8.6 phr, about 8.7 phr, about 8.8 phr, about 8.9 phr, about 9 phr, about 9.1 phr, about 9.2 phr, about 9.3 phr, about 9.4 phr, about 9.5 phr, about 9.6 phr, about 9.7 phr, about 9.8 phr, about 9.9 phr, or about 10 phr.

In some embodiments, the cross-linker is a peroxide type cross-linker.

In some embodiments, dicumyl peroxide (“DCP”) is present as a cross-linker. When present, DCP may be the only cross-linker, or may be one of a plurality of cross-linkers. In some embodiments, DCP is present in an amount of about 0.5 phr to about 10 phr, for example about 1 phr to about 5 phr, such as about 0.5 phr, about 0.6 phr, about 0.7 phr, about 0.8 phr, about 0.9 phr, about 1 phr, about 1.1 phr, about 1.2 phr, about 1.3 phr, about 1.4 phr, about 1.5 phr, about 1.6 phr, about 1.7 phr, about 1.8 phr, about 1.9 phr, about 2 phr, about 2.1 phr, about 2.2 phr, about 2.3 phr, about 2.4 phr, about 2.5 phr, about 2.6 phr, about 2.7 phr, about 2.8 phr, about 2.9 phr, about 3 phr, about 3.1 phr, about 3.2 phr, about 3.3 phr, about 3.4 phr, about 3.5 phr, about 3.6 phr, about 3.7 phr, about 3.8 phr, about 3.9 phr, about 4 phr, about 4.1 phr, about 4.2 phr, about 4.3 phr, about 4.4 phr, about 4.5 phr, about 4.6 phr, about 4.7 phr, about 4.8 phr, about 4.9 phr, about 5 phr, about 5.1 phr, about 5.2 phr, about 5.3 phr, about 5.4 phr, about 5.5 phr, about 5.6 phr, about 5.7 phr, about 5.8 phr, about 5.9 phr, about 6 phr, about 6.1 phr, about 6.2 phr, about 6.3 phr, about 6.4 phr, about 6.5 phr, about 6.6 phr, about 6.7 phr, about 6.8 phr, about 6.9 phr, about 7 phr, about 7.1 phr, about 7.2 phr, about 7.3 phr, about 7.4 phr, about 7.5 phr, about 7.6 phr, about 7.7 phr, about 7.8 phr, about 7.9 phr, about 8 phr, about 8.1 phr, about 8.2 phr, about 8.3 phr, about 8.4 phr, about 8.5 phr, about 8.6 phr, about 8.7 phr, about 8.8 phr, about 8.9 phr, about 9 phr, about 9.1 phr, about 9.2 phr, about 9.3 phr, about 9.4 phr, about 9.5 phr, about 9.6 phr, about 9.7 phr, about 9.8 phr, about 9.9 phr, or about 10 phr.

T-butyl peroxybenzoate (“TBPB”) may be present as the only cross-linker, or as one of a plurality of cross-linker. When included, TBPB may be present in an amount of about 0.5 phr to about 10 phr, for example about 1 phr to about 5 phr, such as about 0.5 phr, about 0.6 phr, about 0.7 phr, about 0.8 phr, about 0.9 phr, about 1 phr, about 1.1 phr, about 1.2 phr, about 1.3 phr, about 1.4 phr, about 1.5 phr, about 1.6 phr, about 1.7 phr, about 1.8 phr, about 1.9 phr, about 2 phr, about 2.1 phr, about 2.2 phr, about 2.3 phr, about 2.4 phr, about 2.5 phr, about 2.6 phr, about 2.7 phr, about 2.8 phr, about 2.9 phr, about 3 phr, about 3.1 phr, about 3.2 phr, about 3.3 phr, about 3.4 phr, about 3.5 phr, about 3.6 phr, about 3.7 phr, about 3.8 phr, about 3.9 phr, about 4 phr, about 4.1 phr, about 4.2 phr, about 4.3 phr, about 4.4 phr, about 4.5 phr, about 4.6 phr, about 4.7 phr, about 4.8 phr, about 4.9 phr, about 5 phr, about 5.1 phr, about 5.2 phr, about 5.3 phr, about 5.4 phr, about 5.5 phr, about 5.6 phr, about 5.7 phr, about 5.8 phr, about 5.9 phr, about 6 phr, about 6.1 phr, about 6.2 phr, about 6.3 phr, about 6.4 phr, about 6.5 phr, about 6.6 phr, about 6.7 phr, about 6.8 phr, about 6.9 phr, about 7 phr, about 7.1 phr, about 7.2 phr, about 7.3 phr, about 7.4 phr, about 7.5 phr, about 7.6 phr, about 7.7 phr, about 7.8 phr, about 7.9 phr, about 8 phr, about 8.1 phr, about 8.2 phr, about 8.3 phr, about 8.4 phr, about 8.5 phr, about 8.6 phr, about 8.7 phr, about 8.8 phr, about 8.9 phr, about 9 phr, about 9.1 phr, about 9.2 phr, about 9.3 phr, about 9.4 phr, about 9.5 phr, about 9.6 phr, about 9.7 phr, about 9.8 phr, about 9.9 phr, or about 10 phr.

Triallyl isocyanurate (“TAIC”) may be present as the only cross-linker, or as one of a plurality of cross-linker. When included, TAIC may be present in an amount of about 0.5 phr to about 10 phr, for example about 1 phr to about 5 phr, such as about 0.5 phr, about 0.6 phr, about 0.7 phr, about 0.8 phr, about 0.9 phr, about 1 phr, about 1.1 phr, about 1.2 phr, about 1.3 phr, about 1.4 phr, about 1.5 phr, about 1.6 phr, about 1.7 phr, about 1.8 phr, about 1.9 phr, about 2 phr, about 2.1 phr, about 2.2 phr, about 2.3 phr, about 2.4 phr, about 2.5 phr, about 2.6 phr, about 2.7 phr, about 2.8 phr, about 2.9 phr, about 3 phr, about 3.1 phr, about 3.2 phr, about 3.3 phr, about 3.4 phr, about 3.5 phr, about 3.6 phr, about 3.7 phr, about 3.8 phr, about 3.9 phr, about 4 phr, about 4.1 phr, about 4.2 phr, about 4.3 phr, about 4.4 phr, about 4.5 phr, about 4.6 phr, about 4.7 phr, about 4.8 phr, about 4.9 phr, about 5 phr, about 5.1 phr, about 5.2 phr, about 5.3 phr, about 5.4 phr, about 5.5 phr, about 5.6 phr, about 5.7 phr, about 5.8 phr, about 5.9 phr, about 6 phr, about 6.1 phr, about 6.2 phr, about 6.3 phr, about 6.4 phr, about 6.5 phr, about 6.6 phr, about 6.7 phr, about 6.8 phr, about 6.9 phr, about 7 phr, about 7.1 phr, about 7.2 phr, about 7.3 phr, about 7.4 phr, about 7.5 phr, about 7.6 phr, about 7.7 phr, about 7.8 phr, about 7.9 phr, about 8 phr, about 8.1 phr, about 8.2 phr, about 8.3 phr, about 8.4 phr, about 8.5 phr, about 8.6 phr, about 8.7 phr, about 8.8 phr, about 8.9 phr, about 9 phr, about 9.1 phr, about 9.2 phr, about 9.3 phr, about 9.4 phr, about 9.5 phr, about 9.6 phr, about 9.7 phr, about 9.8 phr, about 9.9 phr, or about 10 phr.

In some embodiments, DCP is present in an amount of about 0.5 phr to about 10 phr, for example about 1 phr to about 5 phr; and TAIC is also present in an amount of about 0.5 phr to about 10 phr, for example about 1 phr to about 5 phr. The DCP and the TAIC may be present in equal amounts (e.g., in an approximate 1:1 ratio), or may be present in a ratio of DCP to TAIC of about 1.1:1 to about 5:1, for example about 1.1:1, about 1.2:1, about 1.3:1, about 1.4:1, about 1.5:1, about 1.6:1, about 1.7:1, about 1.8:1, about 1.9:1, about 2:1, about 2.1:1, about 2.2:1, about 2.3:1, about 2.4:1, about 2.5:1, about 2.6:1, about 2.7:1, about 2.8:1, about 2.9:1, about 3:1, about 3.1:1, about 3.2:1, about 3.3:1, about 3.4:1, about 3.5:1, about 3.6:1, about 3.7:1, about 3.8:1, about 3.9:1, about 4:1, about 4.1:1, about 4.2:1, about 4.3:1, about 4.4:1, about 4.5:1, about 4.6:1, about 4.7:1, about 4.8:1, about 4.9:1, or about 5:1.

In some embodiments, TBPB is present in an amount of about 0.5 phr to about 10 phr, for example about 1 phr to about 5 phr; and TAIC is also present in an amount of about 0.5 phr to about 10 phr, for example about 1 phr to about 5 phr. The TBPB and the TAIC may be present in equal amounts (e.g., in an approximate 1:1 ratio), or may be present in a ratio of TBPB to TAIC of about 1.1:1 to about 5:1, for example about 1.1:1, about 1.2:1, about 1.3:1, about 1.4:1, about 1.5:1, about 1.6:1, about 1.7:1, about 1.8:1, about 1.9:1, about 2:1, about 2.1:1, about 2.2:1, about 2.3:1, about 2.4:1, about 2.5:1, about 2.6:1, about 2.7:1, about 2.8:1, about 2.9:1, about 3:1, about 3.1:1, about 3.2:1, about 3.3:1, about 3.4:1, about 3.5:1, about 3.6:1, about 3.7:1, about 3.8:1, about 3.9:1, about 4:1, about 4.1:1, about 4.2:1, about 4.3:1, about 4.4:1, about 4.5:1, about 4.6:1, about 4.7:1, about 4.8:1, about 4.9:1, or about 5:1.

In some embodiments, a filler is present. For example and without limitation, the filler may comprise, consist essentially of, or consist of a silica. In some embodiments, the silica comprises, consists essentially of, or consists of silicon dioxide. In some embodiments, the silica comprises, consists essentially of, or consist of a capped silica such as a silanized silica. The filler may be present in an amount of 0 phr to about 70 phr, such as about 0.1 phr to about 5 phr, about 5 phr to about 10 phr, about 10 phr to about 20 phr, about 20 phr to about 30 phr, about 30 phr to about 40 phr, about 40 phr to about 50 phr, about 50 phr to about 60 phr, or about 60 phr to about 70 phr. In some embodiments, the filler is present in an amount of about 0.5 phr, about 1 phr, about 1.5 phr, about 2 phr, about 2.5 phr, about 3 phr, about 3.5 phr, about 4 phr, about 4.5 phr, about 5 phr, about 5.5 phr, about 6 phr, about 6.5 phr, about 7 phr, about 7.5 phr, about 8 phr, about 8.5 phr, about 9 phr, about 9.5 phr, about 10 phr, about 11 phr, about 12 phr, about 13 phr, about 14 phr, about 15 phr, about 16 phr, about 17 phr, about 18 phr, about 19 phr, about 20 phr, about 21 phr, about 22 phr, about 23 phr, about 24 phr, about 25 phr, about 26 phr, about 27 phr, about 28 phr, about 29 phr, about 30 phr, about 31 phr, about 32 phr, about 33 phr, about 34 phr, about 35 phr, about 36 phr, about 37 phr, about 38 phr, about 39 phr, about 40 phr, about 41 phr, about 42 phr, about 43 phr, about 44 phr, about 45 phr, about 46 phr, about 47 phr, about 48 phr, about 49 phr, about 50 phr, about 51 phr, about 52 phr, about 53 phr, about 54 phr, about 55 phr, about 56 phr, about 57 phr, about 58 phr, about 59 phr, about 60 phr, about 61 phr, about 62 phr, about 63 phr, about 64 phr, about 65 phr, about 66 phr, about 67 phr, about 68 phr, about 69 phr, or about 70 phr.

When present as a silanized silica, the filler may be prepared, for example, by mixing dried silica with a silane-donating agent (e.g., methyltris(dimethylsiloxy)silane, phenyltris(dimethylsiloxy)silane), and/or tetrakis(dimethylsiloxy)silane) to produce silanized silica. For example and without limitation, silanized silica may be prepared by heating silica in an oven at about 100° C. to about 140° C. (e.g., at about 120° C.) for about 30 minutes to about 2 hours (e.g., about 1 hour) to remove any residual moisture, followed by mixing with 12% silane to produce silanized silica. The use of silanized silica may be advantageous in curable rubber compositions of the present disclosure to reduce the acidity of standard (e.g., uncapped) silica. Without wishing to be bound by theory, it is presently believed that capping hydroxyl groups of standard silica with silane may reduce or even prevent acid-driven decomposition of the rubber (e.g., cured rubber) over time.

One or more activators may be present. For example and without limitation, zinc oxide, such as nanoparticulate zinc oxide, may be present as the only activator or as one of a plurality of activators. In some embodiments, the curable rubber composition includes an activator but no cross-linker. In some embodiments, the activator is present in an amount of about 0.1 phr to about 5 phr, for example about 0.5 phr to about 2 phr, such as about 0.1 phr, about 0.2 phr, about 0.3 phr, about 0.4 phr, about 0.5 phr, about 0.6 phr, about 0.7 phr, about 0.8 phr, about 0.9 phr, about 1 phr, about 1.1 phr, about 1.2 phr, about 1.3 phr, about 1.4 phr, about 1.5 phr, about 1.6 phr, about 1.7 phr, about 1.8 phr, about 1.9 phr, about 2 phr, about 2.1 phr, about 2.2 phr, about 2.3 phr, about 2.4 phr, about 2.5 phr, about 2.6 phr, about 2.7 phr, about 2.8 phr, about 2.9 phr, about 3 phr, about 3.1 phr, about 3.2 phr, about 3.3 phr, about 3.4 phr, about 3.5 phr, about 3.6 phr, about 3.7 phr, about 3.8 phr, about 3.9 phr, about 4 phr, about 4.1 phr, about 4.2 phr, about 4.3 phr, about 4.4 phr, about 4.5 phr, about 4.6 phr, about 4.7 phr, about 4.8 phr, about 4.9 phr, or about 5 phr.

One or more anti-oxidants may be present. In some embodiments, butylated hydroxytoluene (“BHT”) may be present as the only anti-oxidant, or as one of a plurality of anti-oxidants. When included, BHT may be present in an amount of about 0.1 phr to about 10 phr, for example about 1 phr to about 4 phr, such as about 0.1 phr, about 0.2 phr, about 0.3 phr, about 0.4 phr, about 0.5 phr, about 0.6 phr, about 0.7 phr, about 0.8 phr, about 0.9 phr, about 1 phr, about 1.1 phr, about 1.2 phr, about 1.3 phr, about 1.4 phr, about 1.5 phr, about 1.6 phr, about 1.7 phr, about 1.8 phr, about 1.9 phr, about 2 phr, about 2.1 phr, about 2.2 phr, about 2.3 phr, about 2.4 phr, about 2.5 phr, about 2.6 phr, about 2.7 phr, about 2.8 phr, about 2.9 phr, about 3 phr, about 3.1 phr, about 3.2 phr, about 3.3 phr, about 3.4 phr, about 3.5 phr, about 3.6 phr, about 3.7 phr, about 3.8 phr, about 3.9 phr, about 4 phr, about 4.1 phr, about 4.2 phr, about 4.3 phr, about 4.4 phr, about 4.5 phr, about 4.6 phr, about 4.7 phr, about 4.8 phr, about 4.9 phr, about 5 phr, about 5.1 phr, about 5.2 phr, about 5.3 phr, about 5.4 phr, about 5.5 phr, about 5.6 phr, about 5.7 phr, about 5.8 phr, about 5.9 phr, about 6 phr, about 6.1 phr, about 6.2 phr, about 6.3 phr, about 6.4 phr, about 6.5 phr, about 6.6 phr, about 6.7 phr, about 6.8 phr, about 6.9 phr, about 7 phr, about 7.1 phr, about 7.2 phr, about 7.3 phr, about 7.4 phr, about 7.5 phr, about 7.6 phr, about 7.7 phr, about 7.8 phr, about 7.9 phr, about 8 phr, about 8.1 phr, about 8.2 phr, about 8.3 phr, about 8.4 phr, about 8.5 phr, about 8.6 phr, about 8.7 phr, about 8.8 phr, about 8.9 phr, about 9 phr, about 9.1 phr, about 9.2 phr, about 9.3 phr, about 9.4 phr, about 9.5 phr, about 9.6 phr, about 9.7 phr, about 9.8 phr, about 9.9 phr, or about 10 phr.

2,2′-Methylenebis(4-methyl-6-tert-butylphenol), also referred to as “Antioxidant 2246,” may be present as the only anti-oxidant or as one of a plurality of anti-oxidants. When included, Antioxidant 2246 may be present in an amount of about 0.01 phr to about 5 phr, for example about 0.5 phr to about 2 phr, such as about 0.01 phr, about 0.02 phr, about 0.03 phr, about 0.04 phr, about 0.05 phr, about 0.06 phr, about 0.07 phr, about 0.08 phr, about 0.09 phr, about 0.1 phr, about 0.11 phr, about 0.12 phr, about 0.13 phr, about 0.14 phr, about 0.15 phr, about 0.16 phr, about 0.17 phr, about 0.18 phr, about 0.19 phr, about 0.2 phr, about 0.21 phr, about 0.22 phr, about 0.23 phr, about 0.24 phr, about 0.25 phr, about 0.26 phr, about 0.27 phr, about 0.28 phr, about 0.29 phr, about 0.3 phr, about 0.31 phr, about 0.32 phr, about 0.33 phr, about 0.34 phr, about 0.35 phr, about 0.36 phr, about 0.37 phr, about 0.38 phr, about 0.39 phr, about 0.4 phr, about 0.41 phr, about 0.42 phr, about 0.43 phr, about 0.44 phr, about 0.45 phr, about 0.46 phr, about 0.47 phr, about 0.48 phr, about 0.49 phr, about 0.5 phr, about 0.51 phr, about 0.52 phr, about 0.53 phr, about 0.54 phr, about 0.55 phr, about 0.56 phr, about 0.57 phr, about 0.58 phr, about 0.59 phr, about 0.6 phr, about 0.61 phr, about 0.62 phr, about 0.63 phr, about 0.64 phr, about 0.65 phr, about 0.66 phr, about 0.67 phr, about 0.68 phr, about 0.69 phr, about 0.7 phr, about 0.71 phr, about 0.72 phr, about 0.73 phr, about 0.74 phr, about 0.75 phr, about 0.76 phr, about 0.77 phr, about 0.78 phr, about 0.79 phr, about 0.8 phr, about 0.81 phr, about 0.82 phr, about 0.83 phr, about 0.84 phr, about 0.85 phr, about 0.86 phr, about 0.87 phr, about 0.88 phr, about 0.89 phr, about 0.9 phr, about 0.91 phr, about 0.92 phr, about 0.93 phr, about 0.94 phr, about 0.95 phr, about 0.96 phr, about 0.97 phr, about 0.98 phr, about 0.99 phr, about 1 phr, about 1.01 phr, about 1.02 phr, about 1.03 phr, about 1.04 phr, about 1.05 phr, about 1.06 phr, about 1.07 phr, about 1.08 phr, about 1.09 phr, about 1.1 phr, about 1.11 phr, about 1.12 phr, about 1.13 phr, about 1.14 phr, about 1.15 phr, about 1.16 phr, about 1.17 phr, about 1.18 phr, about 1.19 phr, about 1.2 phr, about 1.21 phr, about 1.22 phr, about 1.23 phr, about 1.24 phr, about 1.25 phr, about 1.26 phr, about 1.27 phr, about 1.28 phr, about 1.29 phr, about 1.3 phr, about 1.31 phr, about 1.32 phr, about 1.33 phr, about 1.34 phr, about 1.35 phr, about 1.36 phr, about 1.37 phr, about 1.38 phr, about 1.39 phr, about 1.4 phr, about 1.41 phr, about 1.42 phr, about 1.43 phr, about 1.44 phr, about 1.45 phr, about 1.46 phr, about 1.47 phr, about 1.48 phr, about 1.49 phr, about 1.5 phr, about 1.51 phr, about 1.52 phr, about 1.53 phr, about 1.54 phr, about 1.55 phr, about 1.56 phr, about 1.57 phr, about 1.58 phr, about 1.59 phr, about 1.6 phr, about 1.61 phr, about 1.62 phr, about 1.63 phr, about 1.64 phr, about 1.65 phr, about 1.66 phr, about 1.67 phr, about 1.68 phr, about 1.69 phr, about 1.7 phr, about 1.71 phr, about 1.72 phr, about 1.73 phr, about 1.74 phr, about 1.75 phr, about 1.76 phr, about 1.77 phr, about 1.78 phr, about 1.79 phr, about 1.8 phr, about 1.81 phr, about 1.82 phr, about 1.83 phr, about 1.84 phr, about 1.85 phr, about 1.86 phr, about 1.87 phr, about 1.88 phr, about 1.89 phr, about 1.9 phr, about 1.91 phr, about 1.92 phr, about 1.93 phr, about 1.94 phr, about 1.95 phr, about 1.96 phr, about 1.97 phr, about 1.98 phr, about 1.99 phr, about 2 phr, about 2.05 phr, about 2.1 phr, about 2.15 phr, about 2.2 phr, about 2.25 phr, about 2.3 phr, about 2.35 phr, about 2.4 phr, about 2.45 phr, about 2.5 phr, about 2.55 phr, about 2.6 phr, about 2.65 phr, about 2.7 phr, about 2.75 phr, about 2.8 phr, about 2.85 phr, about 2.9 phr, about 2.95 phr, about 3 phr, about 3.05 phr, about 3.1 phr, about 3.15 phr, about 3.2 phr, about 3.25 phr, about 3.3 phr, about 3.35 phr, about 3.4 phr, about 3.45 phr, about 3.5 phr, about 3.55 phr, about 3.6 phr, about 3.65 phr, about 3.7 phr, about 3.75 phr, about 3.8 phr, about 3.85 phr, about 3.9 phr, about 3.95 phr, about 4 phr, about 4.05 phr, about 4.1 phr, about 4.15 phr, about 4.2 phr, about 4.25 phr, about 4.3 phr, about 4.35 phr, about 4.4 phr, about 4.45 phr, about 4.5 phr, about 4.55 phr, about 4.6 phr, about 4.65 phr, about 4.7 phr, about 4.75 phr, about 4.8 phr, about 4.85 phr, about 4.9 phr, about 4.95 phr, or about 5 phr.

In some embodiments, BHT is present in an amount of about 0.1 phr to about 10 phr, for example about 1 phr to about 4 phr; and Antioxidant 2246 is also present in an amount of about 0.01 phr to about 5 phr, for example about 0.5 phr to about 2 phr. The BHT and the Antioxidant 2246 may be present in equal amounts (e.g., in an approximate 1:1 ratio), or may be present in a ratio of BHT to Antioxidant 2246 of about 1:10 to about 10:1, for example about 1:9.9, about 1:9.8, about 1:9.7, about 1:9.6, about 1:9.5, about 1:9.4, about 1:9.3, about 1:9.2, about 1:9.1, about 1:9, about 1:8.9, about 1:8.8, about 1:8.7, about 1:8.6, about 1:8.5, about 1:8.4, about 1:8.3, about 1:8.2, about 1:8.1, about 1:8, about 1:7.9, about 1:7.8, about 1:7.7, about 1:7.6, about 1:7.5, about 1:7.4, about 1:7.3, about 1:7.2, about 1:7.1, about 1:7, about 1:6.9, about 1:6.8, about 1:6.7, about 1:6.6, about 1:6.5, about 1:6.4, about 1:6.3, about 1:6.2, about 1:6.1, about 1:6, about 1:5.9, about 1:5.8, about 1:5.7, about 1:5.6, about 1:5.5, about 1:5.4, about 1:5.3, about 1:5.2, about 1:5.1, about 1:5, about 1:4.9, about 1:4.8, about 1:4.7, about 1:4.6, about 1:4.5, about 1:4.4, about 1:4.3, about 1:4.2, about 1:4.1, about 1:4, about 1:3.9, about 1:3.8, about 1:3.7, about 1:3.6, about 1:3.5, about 1:3.4, about 1:3.3, about 1:3.2, about 1:3.1, about 1:3, about 1:2.9, about 1:2.8, about 1:2.7, about 1:2.6, about 1:2.5, about 1:2.4, about 1:2.3, about 1:2.2, about 1:2.1, about 1:2, about 1:1.9, about 1:1.8, about 1:1.7, about 1:1.6, about 1:1.5, about 1:1.4, about 1:1.3, about 1:1.2, about 1:1.1, about 1:1, about 1.1:1, about 1.2:1, about 1.3:1, about 1.4:1, about 1.5:1, about 1.6:1, about 1.7:1, about 1.8:1, about 1.9:1, about 2:1, about 2.1:1, about 2.2:1, about 2.3:1, about 2.4:1, about 2.5:1, about 2.6:1, about 2.7:1, about 2.8:1, about 2.9:1, about 3:1, about 3.1:1, about 3.2:1, about 3.3:1, about 3.4:1, about 3.5:1, about 3.6:1, about 3.7:1, about 3.8:1, about 3.9:1, about 4:1, about 4.1:1, about 4.2:1, about 4.3:1, about 4.4:1, about 4.5:1, about 4.6:1, about 4.7:1, about 4.8:1, about 4.9:1, about 5:1, about 5.1:1, about 5.2:1, about 5.3:1, about 5.4:1, about 5.5:1, about 5.6:1, about 5.7:1, about 5.8:1, about 5.9:1, about 6:1, about 6.1:1, about 6.2:1, about 6.3:1, about 6.4:1, about 6.5:1, about 6.6:1, about 6.7:1, about 6.8:1, about 6.9:1, about 7:1, about 7.1:1, about 7.2:1, about 7.3:1, about 7.4:1, about 7.5:1, about 7.6:1, about 7.7:1, about 7.8:1, about 7.9:1, about 8:1, about 8.1:1, about 8.2:1, about 8.3:1, about 8.4:1, about 8.5:1, about 8.6:1, about 8.7:1, about 8.8:1, about 8.9:1, about 9:1, about 9.1:1, about 9.2:1, about 9.3:1, about 9.4:1, about 9.5:1, about 9.6:1, about 9.7:1, about 9.8:1, about 9.9:1, or about 10:1.

One or more dyes may be present. For example and without limitation, in embodiments that need only be transparent or substantially transparent to RF or infrared light, carbon black may be included as a dye. In some embodiments, an infrared-transparent dye, such as a black dye, is present. In some embodiments, the black dye is Spectrasol Black RL-D (8.SL.0029D0, Spectra Colors Corp.).

In some embodiments, the curable rubber composition includes a polyisoprene, a filler, an antioxidant, an accelerator, and a crosslinking agent. For example and without limitation, a curable rubber composition consistent with the present disclosure may include a polyisoprene rubber, about 10-20 phr silica as filler, about 1-4 phr BHT as antioxidant, about 1-3 phr TRIM as accelerator, and about 1-8 phr DCP as a peroxide-based crosslinking agent.

In some embodiments, the polyisoprene-containing potting material 400 includes a polyisoprene, a filler, an accelerator, and an activator. For example and without limitation, a potting material 400 consistent with the present disclosure may include a polyisoprene rubber, about 50-70 phr silica (e.g., silanized silica) as filler, about 0.2-2.0 phr TBBS as a primary accelerator, about 0.1-1.0 phr TMTD as secondary accelerator, and about 0.2-2.5 phr zinc oxide (e.g., zinc oxide nanoparticles) as activator.

Generally, curable rubber formulations consistent with these embodiments may be formed by homogenizing rubber at about 48-50° C. in a Banbury-type mixer at 45 rpm for about one minute, followed by slow addition of filler (e.g., silica or silanized silica) over several minutes, followed by stirring for about 10 minutes. The activator and accelerator(s) are then added with stirring over several minutes.

In some embodiments, the curable rubber composition includes a polyisoprene, no filler, a co-agent, an antioxidant, and a cross-linking agent. For example and without limitation, a curable rubber composition consistent with the present disclosure may include a polyisoprene rubber (e.g., Isolene 400S), about 0.2-2 phr TAIC as co-agent, about 0.2-2 phr Antioxidant 2246 as antioxidant, and about 1-8 phr DCP as cross-linking agent.

In some embodiments, the curable rubber composition includes a polyisoprene, a filler, a co-agent, a peroxide cross-linking agent. For example and without limitation, a curable rubber composition of this type may include a polyisoprene rubber (e.g., Isolene 400S), about 0.1-2 phr silica as filler, about 0.4-3 phr TAIC as co-agent, and about 1-8 phr TBPB as cross-linking agent.

Generally, curable rubber compositions consistent with these embodiments may be prepared by combining the polyisoprene component, the filler, and the co-agent in a mixer for several minutes at about 150° C. After allowing the mixture to cool, the cross-linking agent is added with stirring for several more minutes.

Compression molding of curable rubber compositions of this type may occur at about 50-60° C. and at about 3 psi over about 1-2 hours, resulting in clear or transparent cured material having a hardness rating of about 70-90 Shore A.

In some embodiments, the rubber composition after curing is transparent or substantially transparent to infrared light, visible light, radio frequencies, and/or UV light. The curable rubber composition, after curing, should not include significant haze or air bubbles after curing. In some embodiments, the curable rubber composition, after curing, has a glass transition not warmer than about −10° C. and remains relatively soft at temperatures higher than about −10° C.

Generally, curable rubber compositions consistent with the present disclosure bond to rubber (e.g., to vulcanized rubber) after curing.

In some embodiments, the curable rubber composition has a relatively low viscosity to enable the composition to flow into small gaps before curing.

In some embodiments, the curable rubber composition is not electrically conductive.

In some embodiments, the curable rubber composition is capable of curing (e.g., substantially curing) in about 4 hours or less. In some embodiments, the curable rubber composition may be cured (e.g., substantially cured) in not more than about 4 hours, for example in not more than about 4 hours, in not more than about 3.5 hours, in not more than about 3 hours, in not more than about 2.5 hours, in not more than about 2 hours, in not more than about 1.5 hours, in not more than about 1 hours, or in not more than about 0.5 hours.

In some embodiments, the curable rubber composition cures in the presence of sulfur. In some embodiments, the curable rubber composition cures without requiring contact with an organometallic catalyst. In some embodiments, the curable rubber composition cures in the presence of UV light. In some embodiments the curable rubber composition cures at a temperature not more than about 66° C. (about 150° F.).

After curing, the rubber compositions of the present disclosure may have a hardness rating of about 50 Shore A or greater, such as about 50 Shore A, about 60 Shore A, about 70 Shore A, about 80 Shore A, or about 90 Shore A.

In some embodiments, the cured rubber material has a relatively low coefficient of thermal expansion, for example to reduce or eliminate the risk of structural fatigue associated with temperature fluctuations in the environment surrounding the cured rubber material.

In some embodiments, the curable rubber composition can be cured by contacting the curable rubber composition with UV light.

In some embodiments, the curable rubber composition can be cured by contacting the curable rubber composition with heat. For example and without limitation, curing the rubber compositions consistent with the present disclosure may comprise contacting the rubber composition with heat at a temperature of not more than about 66° C., not more than about 65° C., not more than about 64° C., not more than about 63° C., not more than about 62° C., not more than about 61° C., not more than about 60° C., not more than about 59° C., not more than about 58° C., not more than about 57° C., not more than about 56° C., not more than about 55° C., not more than about 54° C., not more than about 53° C., not more than about 52° C., not more than about 51° C., not more than about 50° C., not more than about 49° C., not more than about 48° C., not more than about 47° C., not more than about 46° C., not more than about 45° C., not more than about 44° C., not more than about 43° C., not more than about 42° C., not more than about 41° C., not more than about 40° C., not more than about 39° C., not more than about 38° C., not more than about 37° C., not more than about 36° C., not more than about 35° C., not more than about 34° C., not more than about 33° C., not more than about 32° C., not more than about 31° C., not more than about 30° C., not more than about 29° C., not more than about 28° C., not more than about 27° C., not more than about 26° C., or not more than about 25° C.

### EXAMPLES

### Example 1

A curable rubber composition consistent with the present disclosure was prepared including a polyisoprene rubber, silica as filler, BHT as antioxidant, TRIM as accelerator, and DCP as a peroxide-based crosslinking agent in the amounts set forth in Table 1 below.

TABLE 1
Polyisoprene Rubber Formulation 1.

| Component | Species | CAS | Amount (phr) |
|---|---|---|---|
| Rubber | Isolene-400S | 308067-72-3 | 100 |
| Filler | Silica | 112926-00-8 | 13 |
| Antioxidant | BHT | 128-37-0 | 2 |
| Accelerator | TRIM | 3290-92-4 | 1 |
| Cross-linking Agent | DCP | 80-43-3 | 4 |

### Example 2

Curable rubber compositions consistent with the present disclosure were prepared including a polyisoprene rubber, silanized silica as filler, nanoparticulate zinc oxide as activator, and TBBS and TMTD as accelerators in the amounts set forth in Tables 2-5 below.

Generally, curable rubber formulations consistent with this Example 2 were formed by homogenizing rubber at about 48-50° C. in a Banbury-type mixer at 45 rpm for about one minute, followed by slow addition of silanized silica over several minutes, followed by stirring for about 10 minutes. The activator and accelerator(s) were then added with stirring over several minutes.

TABLE 2
Polyisoprene Rubber Formulation 2A.

| Component | Species | CAS | Amount (phr) |
|---|---|---|---|
| Rubber | Isolene 400-S | 9003-31-0 | 100 |
| Filler | Silica VN3 silanized | — | 60 |
| | silica | | |
| Primary accelerator | TBBS | 95-31-8 | 0.4 |
| Secondary accelerator | TMTD | 137-26-8 | 0.1 |
| Activator | ZnO (nanoparticles) | 1314-13-2 | 0.5 |

TABLE 3
Polyisoprene Rubber Formulation 2B.

| Component | Species | CAS | Amount (phr) |
|---|---|---|---|
| Rubber | Isolene 400-S | 9003-31-0 | 100 |
| Filler | Silica VN3 silanized | — | 60 |
| | silica | | |
| Primary accelerator | TBBS | 95-31-8 | 0.8 |
| Secondary accelerator | TMTD | 137-26-8 | 0.3 |
| Activator | ZnO (nanoparticles) | 1314-13-2 | 1 |

TABLE 4
Polyisoprene Rubber Formulation 2C.

| Component | Species | CAS | Amount (phr) |
|---|---|---|---|
| Rubber | Isolene 400-S | 9003-31-0 | 100 |
| Filler | Silica VN3 silanized | — | 60 |
| | silica | | |
| Primary accelerator | TBBS | 95-31-8 | 1.2 |
| Secondary accelerator | TMTD | 137-26-8 | 0.5 |
| Activator | ZnO (nanoparticles) | 1314-13-2 | 1.5 |

TABLE 5
Polyisoprene Rubber Formulation 2D.

| Component | Species | CAS | Amount (phr) |
|---|---|---|---|
| Rubber | Isolene 400-S | 9003-31-0 | 100 |
| Filler | Silica VN3 silanized | — | 60 |
| | silica | | |
| Primary accelerator | TBBS | 95-31-8 | 1.6 |
| Secondary accelerator | TMTD | 137-26-8 | 0.7 |
| Activator | ZnO (nanoparticles) | 1314-13-2 | 2 |

These formulations are curable by application of heat below about 66° C. to provide cured rubber compositions having 70-80 Shore A hardness values.

### Example 3

A curable rubber composition consistent with the present disclosure was prepared including a polyisoprene rubber, no filler, TAIC as co-agent, Antioxidant 2246 as antioxidant, and DCP as cross-linking agent in the amounts set forth in Table 6 below.

TABLE 6
Polyisoprene Rubber Formulation 3.

| Component | Species | CAS | Amount (phr) |
|---|---|---|---|
| Rubber | Isolene-400S | 308067-72-3 | 100 |
| Filler | None | — | 0 |
| Co-agent | TAIC | 101-37-1 | 1 |
| Antioxidant | Antioxidant 2246 | 119-47-1 | 1 |
| Cross-linking Agent | DCP | 80-43-3 | 3 |

### Example 4

A curable rubber composition consistent with the present disclosure was prepared including Isolene 400S polyisoprene rubber, silica as filler, TAIC as co-agent, and TBPB as cross-linking agent in the amounts set forth in Table 7 below.

Isolene 400S, silica, and TAIC were combined in a mixer for several minutes at about 150° C. After allowing the mixture to cool, TBPB was added with stirring for several more minutes.

TABLE 7
Polyisoprene Rubber Formulation 4.

| Component | Species | CAS | Amount (phr) |
|---|---|---|---|
| Rubber | Isolene-400S | 9003-31-0 | 100 |
| Filler | Silica powder | 7631-86-9 | 0.5 |
| Co-agent | TAIC | 101-37-1 | 1.3 |
| Cross-linking Agent | TBPB | 614-45-9 | 3.5 |

Compression molding of the curable rubber composition of this Example 4 may occur at about 50-60° C. and at about 3 psi over about 1-2 hours, resulting in a clear/transparent cured material having a hardness rating of about 70-90 Shore A.

### CONCLUSION

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

It is to be understood that both the foregoing descriptions are exemplary and explanatory only, and are not restrictive of the methods and devices described herein. In this application, the use of the singular includes the plural unless specifically stated otherwise. Also, the use of “or” means “and/or” unless stated otherwise. Similarly, “comprise,” “comprises,” “comprising,” “include,” “includes” and “including” are not intended to be limiting.

All patents, patent applications, publications, and references cited herein are expressly incorporated by reference to the same extent as if each individual publication or patent application was specifically and individually indicated to be incorporated by reference.

1. (canceled)

2: A rubber composition comprising:
a polyisoprene;
about 10-20 parts per hundred rubber (“phr”) silica as a filler;
about 1-4 phr butylated hydroxytoluene (“BHT”) as an antioxidant;
about 1-3 phr trimethylolpropane trimethacrylate (“TRIM”) as an accelerator; and
about 1-8 phr dicumyl peroxide (“DCP”) as a crosslinking agent.

3-9. (canceled)

10: A rubber composition comprising:
a polyisoprene;
about 0.1-2 phr silica as a filler;
about 0.4-3 phr TAIC as a co-agent; and
about 1-8 phr t-butyl peroxybenzoate (“TBPB”) as a cross-linking agent.

11: The rubber composition of claim 2, wherein the polyisoprene comprises, consists essentially of, or consists of a low molecular weight liquid polymer having a cis-1,4-polyisoprene backbone.

12: The rubber composition of claim 11, wherein the low molecular weight liquid polymer having a cis-1,4-polyisoprene backbone has an average molecular weight of about 60,000 to about 70,000.

13: The rubber composition of claim 12, wherein the low molecular weight liquid polymer having a cis-1,4-polyisoprene backbone is Isolene 400-S(CAS 9003-31-0).

14: The rubber composition of claim 2, wherein the rubber composition is in a liquid state below a temperature of about 55° C.

15: The rubber composition of claim 2, wherein the rubber composition is in a liquid state until being contacted with UV light for a period of time sufficient to cure the rubber composition to a solid or amorphous solid state.

16: A method of protecting an electronic device, the method comprising:
preparing a rubber composition of claim 2;
substantially surrounding the electronic device with the rubber composition; and
thereafter curing the rubber composition by contacting the rubber composition with UV light and/or heat.

17: The method claim 16, wherein the step of curing the rubber composition comprises contacting the rubber composition with heat at not more than about 65° C.

18: The rubber composition of claim 10, wherein the polyisoprene comprises, consists essentially of, or consists of a low molecular weight liquid polymer having a cis-1,4-polyisoprene backbone.

19: The rubber composition of claim 18, wherein the low molecular weight liquid polymer having a cis-1,4-polyisoprene backbone has an average molecular weight of about 60,000 to about 70,000.

20: The rubber composition of claim 19, wherein the low molecular weight liquid polymer having a cis-1,4-polyisoprene backbone is Isolene 400-S(CAS 9003-31-0).

21: The rubber composition of claim 10, wherein the rubber composition is in a liquid state below a temperature of about 55° C.

22: The rubber composition of claim 10, wherein the rubber composition is in a liquid state until being contacted with UV light for a period of time sufficient to cure the rubber composition to a solid or amorphous solid state.

23: A method of protecting an electronic device, the method comprising:
preparing a rubber composition of claim 10;
substantially surrounding the electronic device with the rubber composition; and
thereafter curing the rubber composition by contacting the rubber composition with UV light and/or heat.

24: The method of claim 23, wherein the step of curing the rubber composition comprises contacting the rubber composition with heat at not more than about 65° C.
